(19) United States
(12) Patent Application Publication
(10) Pub. No.: US 2026/0141261 A1
(43) Pub. Date: May 21, 2026

(54) SYSTEMS AND METHODS FOR IMPLEMENTING AN ARTIFICIAL INTELLIGENCE (AI) GUARDRAIL FRAMEWORK

(71) Applicant: Salesforce, Inc., San Francisco, CA (US)

(72) Inventor: Jondean Haley, British Columbia (CA)

(21) Appl. No.: 19/208,036

(22) Filed: May 14, 2025

Related U.S. Application Data
(60) Provisional application No. 63/724,762, filed on Nov. 25, 2024.
(60) Provisional application No. 63/721,803, filed on Nov. 18, 2024.

(51) Int. Cl. G06N 3/10; G06N 3/042

(52) U.S. Cl. CPC G06N 3/10; G06N 3/042

(57) ABSTRACT

Embodiments described herein provide an AI guardrail system that integrates an agentic compliance evaluation framework with an agentic governance ontology framework to automate AI risk assessment and management. For the compliance evaluation framework, embodiments provide a Digital Risk and Compliance Officer (DRCO) agent built upon an LLM to verify AI compliance in an AI system based on a knowledge base managed by an AI governance ontology. For the governance ontology framework, embodiments provide an AI Governance Ontology (GO) agent built upon two LLMs that generate and update a knowledge base representing concepts, relationships, and metadata related to the governance of AI systems based on AI system generated conversation transcripts.

### CROSS REFERENCE(S)

The instant application is related to co-pending and commonly-owned U.S. nonprovisional application entitled “Systems And Methods For Implementing An Artificial Intelligence (AI) Guardrail Framework” (Attorney docket no. 70689.392US01), filed on even date herewith, which is hereby expressly incorporated herein by reference in its entirety.

The instant application is a nonprovisional of and claims priority under 35 U.S.C. 119 to U.S. provisional application no. 63/721,803, filed on November 18, 2024, and U.S. provisional application no. 63/724,762, filed on November 25, 2024, the entire disclosures of which are hereby expressly incorporated by reference herein in their entirety.

### TECHNICAL FIELD

The embodiments relate generally to machine learning systems for implementing an artificial intelligence (AI) governance framework, and more specifically to an AI guardrail framework that automatically detects AI assets to verify AI asset compliance in different AI use cases.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Industries that implement AI and/or AI agents are increasingly affected by proliferating AI constraints. The AI constraints increasingly require companies to have AI governance to track AI inventories, AI regulatory compliance, and reporting compliance to both internal and external stakeholders. However, current AI governance frameworks are often staff-centric, requiring human labor to manually determine whether AI assets, such as an AI agent, an AI feature in a system and/or the like, are operating within up-to-date AI guardrails.

### BRIEF DESCRIPTION OF THE DRAWINGS

FIG. 1 shows an example operation of an LLM based AI agent, according to embodiments of the present disclosure.

FIGS. 2A-2B is a simplified diagram illustrating various aspects of an AI guardrail framework, according to some embodiments.

FIG. 3 illustrates a compliance evaluation framework executed by an AI agent as part of the AI guardrail framework of FIGS. 2A-2B, according to some embodiments.

FIG. 4 illustrates an overview of using the compliance evaluation framework in FIG. 3 to assist governance teams in automating AI risk management, according to some embodiments.

FIG. 5 illustrates a governance ontology framework executed by another AI agent as part of the AI guardrail framework of FIGS. 2A-2B, according to some embodiments.

FIGS. 6A-6B illustrates various components of the governance ontology framework, according to some embodiments.

FIG. 7A is a simplified diagram illustrating a computing device implementing the AI guardrail framework described in FIGS. 2-6, according to some embodiments.

FIG. 7B is a simplified diagram illustrating a neural network structure, according to some embodiments.

FIG. 8 is a simplified block diagram of a networked system suitable for implementing the AI guardrail framework described in FIGS. 2-6 and other embodiments described herein.

FIGS. 9A-9B are example logic flow diagrams illustrating methods of automating aspects of AI risk management based on the framework shown in FIGS. 2A-2B, 5, and 6A-6B, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

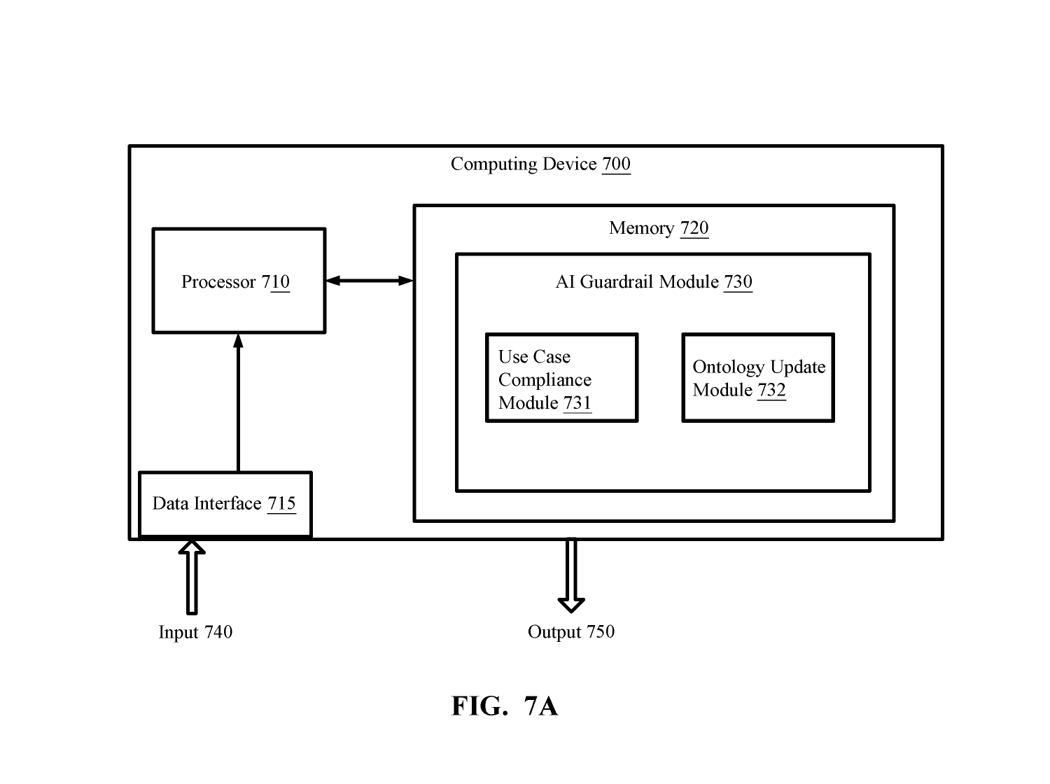

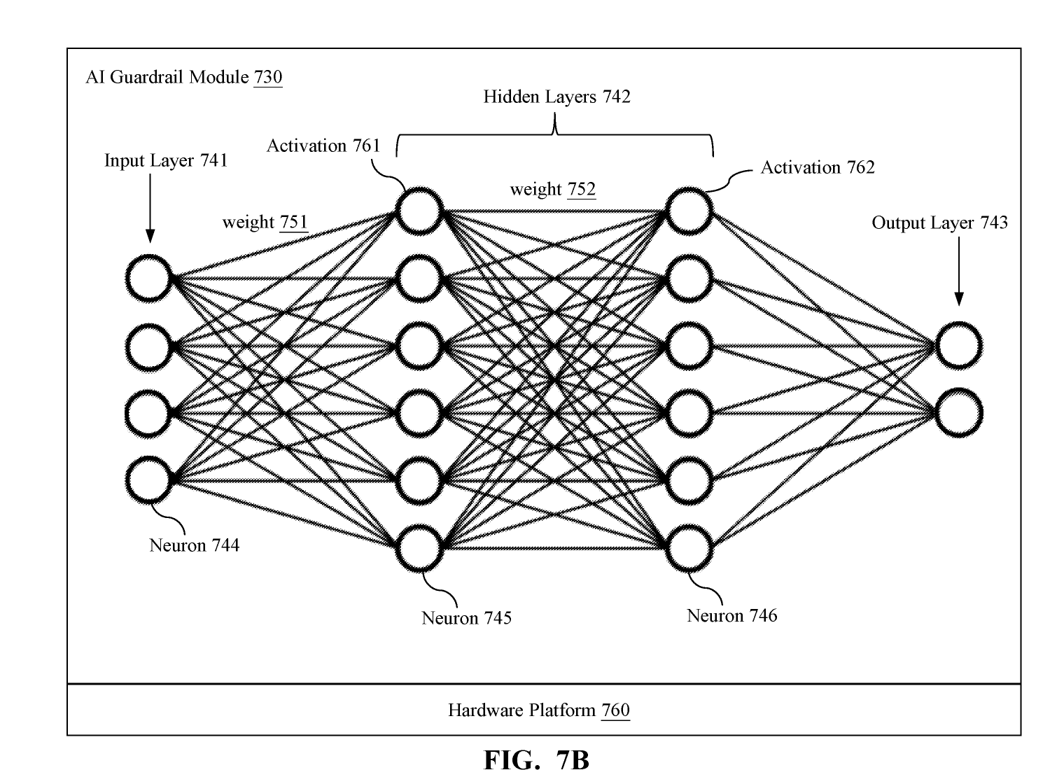

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 7B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

As used herein, the term “AI guardrail” may refer to a system or subsystem implemented to guide, restrict, or control the operation of AI models so that the AI operation may comply with safety, ethical and/or other requirements. For example, AI guardrails may take a variety of forms, including but not limited to hard-coded rules, content filters, alignment techniques, access controls, monitoring systems, and/or the like.

### Overview

AI agents have been widely deployed across a range of applications, e.g., ranging from virtual assistants and customer service bots to autonomous vehicles and medical diagnostics. While these AI systems offer significant benefits, they also pose serious challenges—particularly around user privacy, the spread of misinformation, and the handling of confidential data. Without effective AI governance, AI systems may collect and misuse personal data , compromise sensitive business information, or amplify false and misleading content at scale. Addressing these risks requires strong oversight mechanisms, such as enforcing data protection regulations, ensuring algorithmic transparency, and establishing accountability for content moderation and protection of propriety information. Existing AI governance systems mostly rely on significant manual supervision in monitoring and reporting AI governance results, which often struggle to keep pace with the scale and complexity of modern AI systems.

For these and other reasons, embodiments described herein provide an AI governance system that integrates an agentic compliance evaluation framework with an agentic governance ontology framework to automate AI risk assessment and management. The concept of such an AI governance system is implemented through an operational AI guardrail system, as described herein according to various embodiments.

For the compliance evaluation framework, embodiments herein provide an AI Digital Risk and Compliance Officer (DRCO) agent operating within the AI guardrail system and built upon an LLM to verify AI compliance in an AI system based on a knowledge base managed by an AI governance ontology. The AI DRCO agent (referred herein simply as DRCO agent) may automate a workflow to create an AI Use Case Object based on detected AI assets (e.g., a predictive feature, a response generation feature, etc.) in a system and identify one or more associated compliance checklists based on the AI use case attributes (e.g., AI owner, type, list of compliance checklists, etc.). The LLM of the DRCO agent may thus evaluate the compliance checklists for the AI Use Case Object based on semantic similarity search on a database of AI use cases and their associated compliance checklists. The DRCO agent may send a transcript, e.g., a conversation transcript regarding the detected AI asset and generated use case, to an AI ontology agent to update the AI governance knowledge base and generate AI governance data.

For the governance ontology framework, embodiments herein provide an AI Governance Ontology (GO) agent (referred herein simply as GO agent) operating within the AI guardrail system and built upon two LLMs that generate and update a knowledge base representing concepts, relationships, and metadata related to the governance of AI systems based on AI system generated conversation transcripts. Specifically, a translator LLM may be finetuned to translate a prompt containing a conversation transcript and information of an AI governance ontology knowledge base into ontology updates, and/or a structured summary of the conversation using the terms and concepts defined in the ontology. The created and/or updated knowledge base of AI governance may then be used to query for AI governance concepts. For example, a knowledge base query LLM may be finetuned to query the knowledge base based on a natural language query related to AI governance concepts. The query LLM may in turn generate an Apex DML code that translates the natural language query into the appropriate query language for the underlying graph database (such as SPARQL, Cypher, or GQL) to execute this query so as to retrieve the relevant knowledge subgraph. The retrieved result, e.g., AI governance information relating to the natural language query may be integrated into an AI Governance application’s object model. This result includes metadata necessary for the application, carried within the properties of the returned knowledge graph data. In this way, AI governance information is updated in real-time for AI system governance monitoring and reporting (e.g., the DRCO agent may improve its AI compliance assessment based on updated knowledge graphs managed by the GO agent).

Embodiments described herein provide a number of benefits. The AI guardrail framework allows for autonomous discovery of AI assets, autonomous evaluation of AI asset compliance, and autonomous updates to the AI governance knowledge base based on the autonomous evaluation. This results in more efficient and accurate characterization of AI assets running in production systems. Such a framework for assessing AI compliance facilitates easier adoption of various AI use cases, which may implement various LLM models, according to customer needs. With improved AI governance techniques, neural network technology of constructing (or adopting) various AI models is improved.

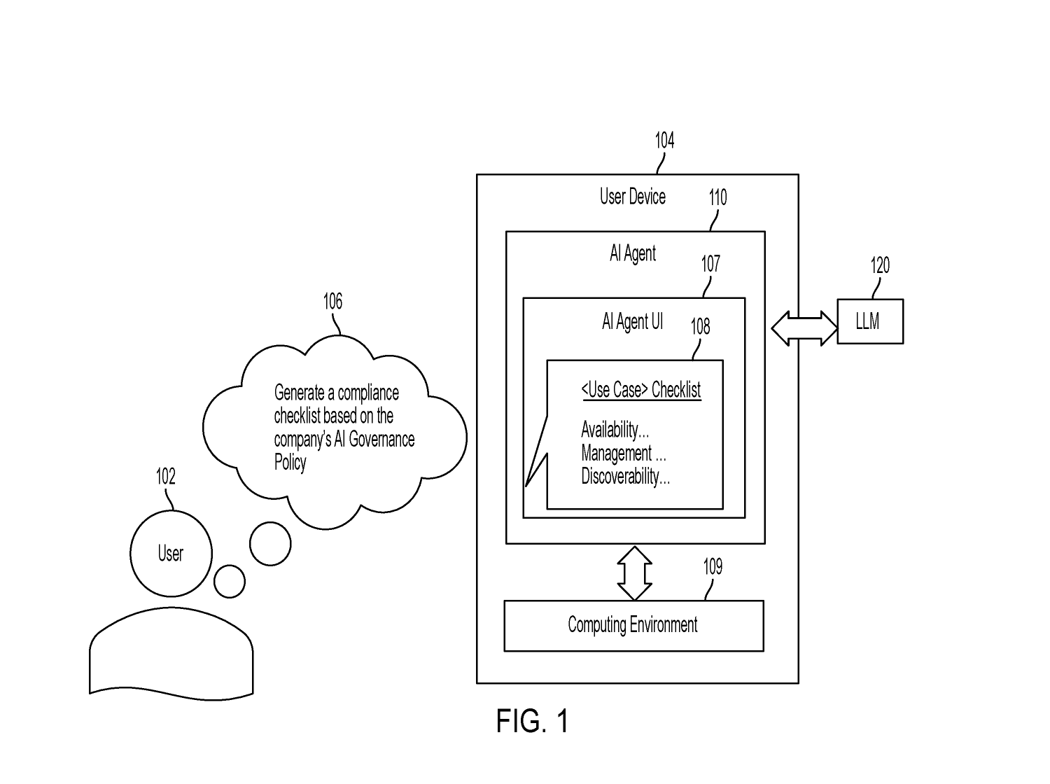

FIG. 1 shows an example operation of an LLM-based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “Generate a compliance checklist based on the company’s AI Governance Policy” 106.

In one embodiment, the AI agent 110 may process the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, text answer, etc. The LLM 120 may in turn generate a response 108 based on an input combining the task request 106 and any system prompt.

The response 108 may include instructions, results, explanations, code scripts or direct actions to address the task request 106. Such response 108 may be displayed via the AI agent interface 107 for transparency (e.g., a communication channel such as Slack). In addition to the response 108 that fulfills or describes how to fulfill the task request, the LLM 120 may generate computer-executable commands (e.g., system-level commands, Python scripts, etc.) that can directly trigger actions and/or interactions with the computing environment 109 on the user device 104. The computing environment may include an AI governance application 250 further described herein.

For example, when the user 102 requests to generate an AI compliance checklist, the LLM 120 may output a code script to execute on the computing environment 109 (such as an application running an AI governance object model) on the user device 104 to search objects in a knowledge base, and/or interface with APIs of other applications, for generating and also enriching a compliance checklist for an AI use case, and/or the like. In this way, the LLM-based AI agent may facilitate end-to-end workflow to automate the task request 106. However, AI agents often only perform specific tasks when prompted by user query. These AI agents do not automate larger workflows comprising multiple interrelated tasks and workflows. Embodiments described herein provide a first tailored AI agent that automatically executes interrelated AI risk assessment tasks in planned sequences based on initial use-case definitions and automatic prompting of AI governance teams. Embodiments described herein also provide a second tailored AI agent that translates human transcripts directed to AI use cases into knowledge base updates to be used by the first AI agent in performing its compliance evaluation tasks.

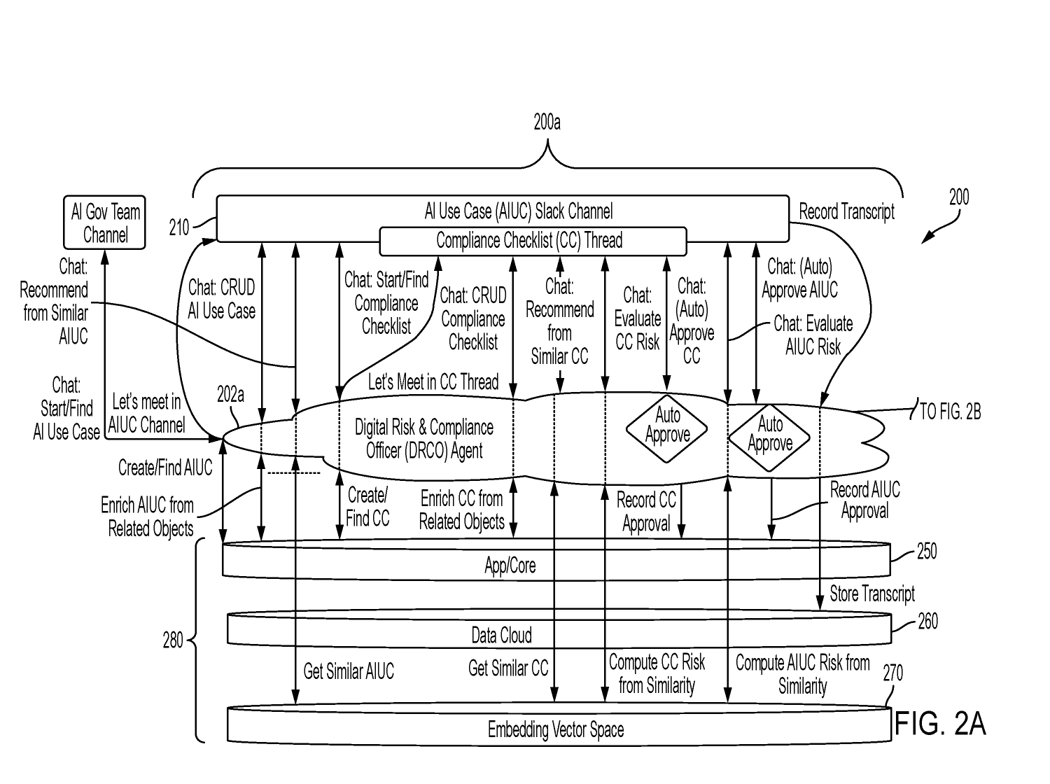

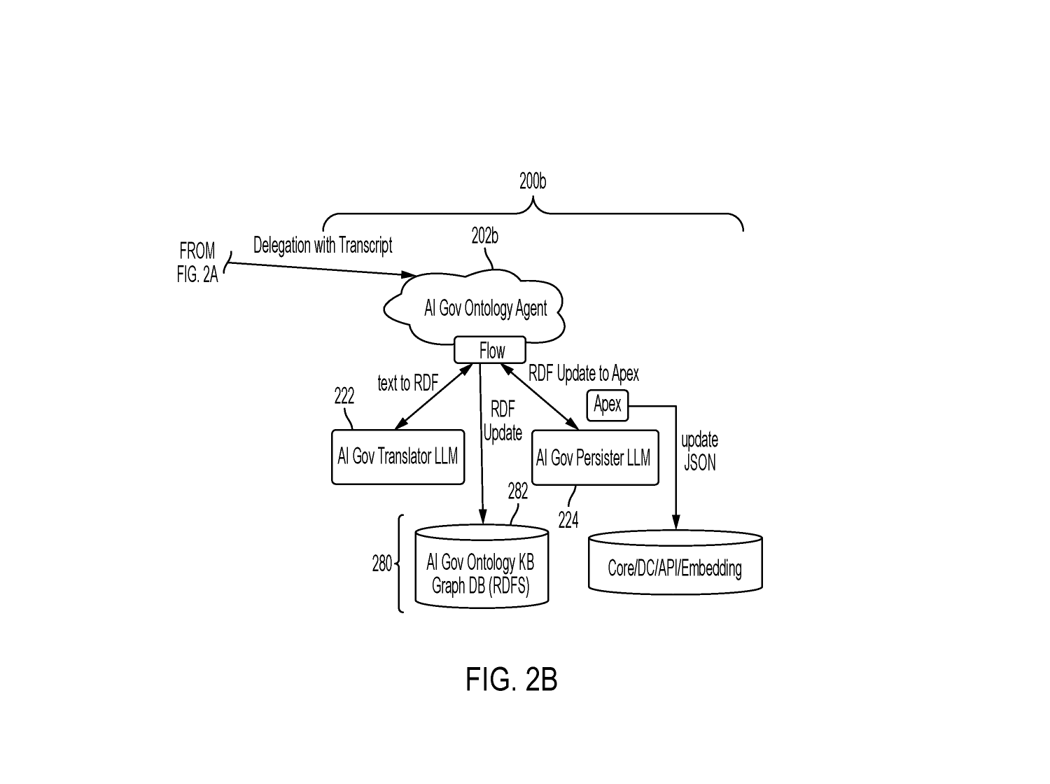

FIGS. 2A-2B is a simplified diagram illustrating various aspects of an AI guardrail framework 200, according to some embodiments. The AI guardrail framework 200 includes two sub-frameworks – a compliance evaluation framework 200a run by the Digital Risk and Compliance Officer (DRCO) agent 202a and a governance ontology framework 200b run by the AI Governance Ontology (GO) agent 202b. The two sub-frameworks are integrated together to automate and to improve quality of AI asset risk assessment. The DRCO agent 202a leverages an AI governance knowledge base 282 to assist AI governance teams in AI asset risk discovery, management, and compliance reporting. The GO agent 202b translates and persists knowledge retrieved from transcripts between the DRCO agent and the AI governance team to update the AI governance knowledge base 282 and the object model used in the evaluation framework 200a.

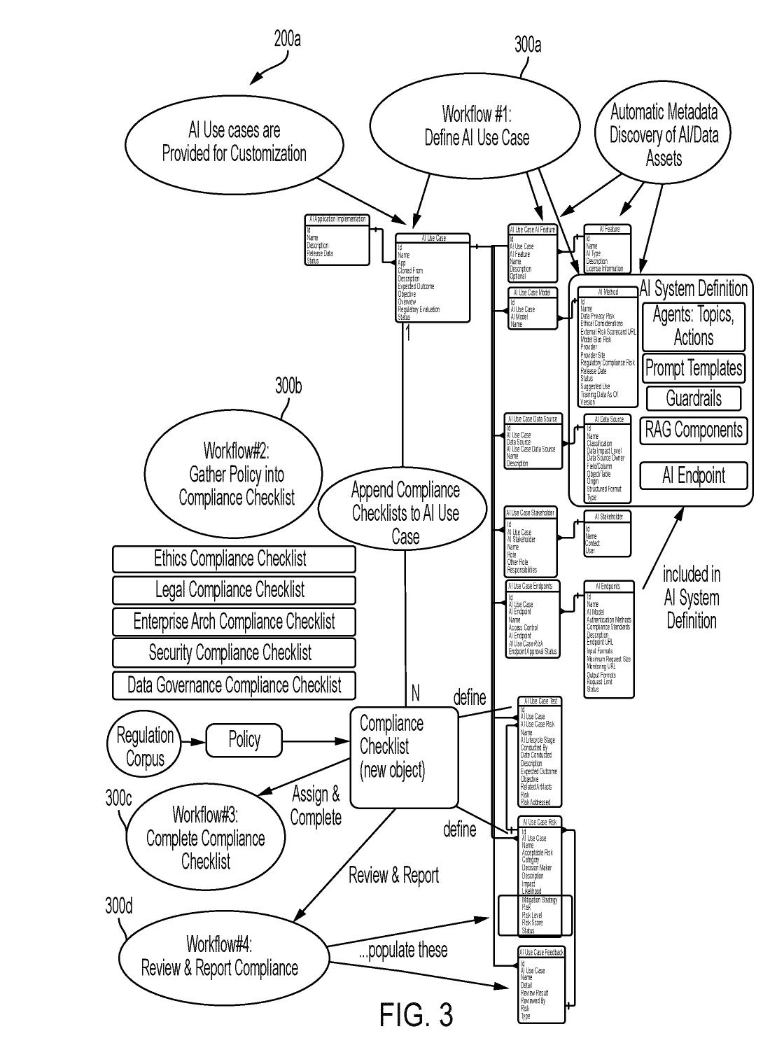

The compliance evaluation framework 200a is described below with reference to FIGS. 2A-2B and 3-4. As shown in FIG. 3, the framework 200a includes a first workflow 300a that defines a new AI Use Case. This includes being provided use cases for customization (e.g., by human data entry) and/or by detecting AI assets in production to perform automatic metadata discovery of AI data assets. In one embodiment, the DRCO agent 202a reads sufficient metadata on an AI asset to construct an AI Use Case, noting itself as author (e.g., via an inference model in a region and via a vertical app, such as AI governance app/core 250). As part of constructing the AI Use Case, the DRCO agent 202a may populate various AI system definitions based on the metadata discovery (e.g., agents, topics, actions, guardrails, etc.), as further described below .

In an example embodiment of the first workflow 300a, the DRCO agent 202a regularly scans production AI platforms to identify all operating AI assets. Production AI platforms may be multi-cloud AI and/or AI data assets of various types, including predictive, generative, and agentic AI. For each identified AI asset, the DRCO agent 202a checks whether there is an existing approved AI Use Case linked to it (e.g., by reading metadata of the AI asset). If an AI asset is found without an approved AI Use Case, the DRCO agent 202a automatically initiates the creation of a new AI Use Case. To instantiate a new AI Use Case, the DRCO agent 202a extracts relevant metadata from the discovered AI Asset. This metadata typically includes information such as the asset’s business purpose, region, vertical, team, and technical details. The DRCO agent 202a then alerts an AI governance team the discovery of the AI asset and the instantiation of the new AI Use Case.

After the AI Use Case is instantiated, the DRCO agent 202a may trigger and execute a Use Case definition pipeline. The Use Case definition pipeline includes the creation and the enrichment of an AI Use Case Object, which defines the newly instantiated AI Use Case. The AI Use Case definition pipeline further includes the creation of an associated AI Use Case communication channel (e.g., a Slack channel 210), which provides a contained platform for an associated AI governance team to communicate with the DRCO agent 202a. Inputs from the AI governance team may further shape and define the AI Use Case Object. The Use Case definition pipeline may be automatically triggered after Use Case instantiation. Alternatively, the Use Case definition pipeline may be triggered by user request from the AI Use Case owner. For example, the DRCO agent 202a may have already instantiated several new AI Use Cases that are not yet processed and approved. These AI Use Cases are stored in queue and later processed upon user request from the associated Use Case owner.

The DRCO agent 202a defines the AI Use Case Object by populating various use case attributes, which may be fields of the Use Case Object or even objects themselves. These attributes may include Owner, AI type, List of ComplianceChecklists, Required ComplianceChecklists Specification, Description, RiskFormula, Risk, RiskMitigationThreshold, RiskAutomationThreshold, State, AIUseCaseComplianceReport, CollaborationChannel, and Transcript. These attributes may be automatically generated by the DRCO agent 202a. For example, the DRCO agent 202a extracts relevant metadata from discovered AI Assets, including business purpose, region, vertical, team, and technical details. Then the DRCO agent 202a uses this metadata to automatically generate the Description and other attributes. These attributes may also be refined and updated through governance team input in the communication channel 210 or semantic search. For example, the DRCO agent 202a performs semantic search to retrieve similar approved AI Use Cases based on Description similarity for reference and reuse.

The Owner attribute defines the identity in charge of the AI Use Case in the overlying AI governance application. The AI type attribute is a customizable enumeration of the classification of AI Use Cases (e.g., predictive, generative, agentic). The List of ComplianceChecklists attribute identifies all the ComplianceChecklists Objects attached to the AI Use Case Object. The Required ComplianceChecklists Specification attribute specifies which ComplianceChecklists must be approved for the AI Use Case Object to move to the Approved State.

The Description attribute is an initial ComplianceChecklist Object attached to the AI Use Case Object at AI Use Case instantiation. This ComplianceChecklist Object is a required compliance checklist that must be approved. The Description attribute captures all of the parameters of the AI Use Case, including AI Type (e.g., predictive, generative, agentic), business purpose, region, vertical, team, and other customizable attributes.

The RiskFormula attribute defines a formula over the risks of all ComplianceChecklists in the Required ComplianceChecklists Specification, resulting in a real number in [0,1]. The Risk attribute defines a computed risk value as a real number in [0,1] based on the RiskFormula. The risk value is computed by applying the RiskFormula to all Approved ComplianceChecklists in the Required ComplianceChecklists Specification. The risk value is dynamic over the lifecycle of the AI Use Case and may increase/decrease as ComplianceChecklists are Approved. The RiskMitigationThrehold attribute defines a threshold at which the DRCO agent 202a alerts experts to begin a Risk Mitigation workflow. The Risk Mitigation workflow may include removal from production usage and/or alteration and re-assessment of the underlying AI assets. For example, once an AI asset or use case is determined “risky” or fail to pass “compliance,” it may be automatically disabled by the DRCO agent 202a, such that all or portions of the data traffic coming from the AI asset is blocked. The RiskAutomationThreshold attribute defines a threshold under which DRCO auto-approvals may proceed.

The State attribute defines four states - New, InProgress, Complete, and Approved. The New state means the AI Use Case Object is newly instantiated with the required Description and having the initial ComplianceChecklist. The InProgress state means the AI Use case is being worked on by the DRCO agent 202a and the governance team. The Complete state means all ComplianceChecklists of the Required ComplianceChecklists Specification are attached and Approved. And the Approved state means the AI Use Case is approved by the DRCO agent 202a or the governance team.

The AIUseCaseComplianceReport attribute is a reference to the Compliance Report of the AI Use Case. The CollaborationChannel attribute is a reference to the collaboration channel used for ComplianceChecklist completion (e.g., the Slack channel 210). The Transcript attribute is a reference to storage of the transcript of the collaboration channel between team members of the governance team and the DRCO agent 202a.

As shown in FIGS. 2A-2B, and as part of the first workflow 300a, the DRCO agent 202a may refine and enrich the AI Use Case Object, along with its associated attributes, through interactions in the communication channel 210 and interactions with a storage system 280. The storage system 280 may be a computing and/or storage platform that includes processors and/or storage that host the AI governance app/core 250, the data cloud 260, and the embedding vector space 270. Upon creating the AI Use Case Object, the DRCO agent 202a may enrich the Object from related objects via the app/core 250. The DRCO agent 202a may further enrich the Object by identifying and accessing similar AI Use Case Objects from the embedding vector space 270. Relevant attributes may be retrieved to shape the new AI Use Case Object. These enrichments may be prompted by the governance team via the communication channel 210, or they may be automatically performed by the DRCO agent 202a. As part of creating the AI Use Case Object, and as previously described, the DRCO agent 202a also identifies an initial compliance checklist (CC) that is attached to the AI Use Case Object (e.g., via the app/core 250). Transcripts of the collaboration between governance teams and the DRCO agent in the channel 210 are appended to the audit trail for the AI Use Case Object.

As shown in FIG. 3, the compliance evaluation framework 200a further includes a second workflow 300b that includes gathering policy into one or more compliance checklists and attaching the one or more checklists as ComplianceChecklist Objects to the AI Use Case Object. The workflow 300b overlaps and may be part of the workflow 300a. But the workflow 300b is focused more on the actual creation and enrichment of the ComplianceChecklist Objects, which as previously described, is a separate object attached to the AI Use Case Object. In one example, the DRCO may first gather relevant regulations from a regulation corpus database to define relevant policy (e.g., from an AI governance knowledge base, such as from ontology knowledge base graph 282). Then, the DRCO casts the policy into compliance checklists, shaped by templates/prompts for each regulatory concern (Ethics, Legal, EA, Security, Data Governance, etc.) and a measured similarity to defined AI Use Cases. As shown, the generated compliance checklists may be appended to the instantiated AI Use Case Object to form a compiled ComplianceChecklist Object. This may be the initial checklist as part of the AI Use Case Object’s Description attribute. Note that additional ComplianceChecklist Objects may be attached to the AI Use Case Object, as deemed necessary by the DRCO agent 202a and/or the associated AI governance team. These may be categorized as required or otherwise based on the Required ComplianceChecklists Specification.

The DRCO agent 202a defines the ComplianceChecklist Object by populating various compliance checklist attributes, which may be fields of the ComplianceChecklist Object or even objects themselves. These attributes may include AI Type, ComplianceChecklistType, ComplianceChecklistDocument, Risk, RiskFormula, ExpertRisk, ComputedRisk, RiskMitigationThreshold, RiskAutomationThreshold, State, and Transcript. These attributes may be automatically generated by the DRCO agent 202a. For example, the DRCO agent 202a may summarize the company’s AI governance policy into specific QA forms. The DRCO agent 202a may also use semantic search to find similar Approved ComplianceChecklists for expert review and justification for approval.

The AI Type attribute may be read from the parent AI Use Case Object. The ComplianceChecklistType attribute defines an enumeration of groups involved in AI Governance, one type per Expert group (e.g., Ethics, Legal). The ComplianceChecklistDocument attribute is a reference to the associated ComplianceChecklistDocument (further described herein). The Risk attribute is a computed risk value in [0,1] based on the RiskFormula, over ExpertRisk and ComputedRisk. The RiskFormula attribute is a weighted average of ExpertRisk and ComputedRisk. The ExpertRisk attribute is a number assigned by an expert, representing the "prior" risk in a Bayesian sense.

The ComputedRisk attribute is a computed number representing the "posterior" risk. The Computed Risk is a numerical value in the range [0,1] that represents the risk level of a ComplianceChecklist Object. It is derived from the similarity to the nearest approved ComplianceChecklist Object of the same AI Type and ComplianceChecklistType. The ComputedRisk is calculated using a similarity metric, such as CosineSimilarity, within a vector space (embedding) (e.g., embedding vector space 270) created for the ComplianceChecklists. The vector subspace is defined by the AI Type and ComplianceChecklistType, ensuring that the comparison is relevant and context-specific. In a Bayesian sense, ComputedRisk is considered the "posterior" risk, which is updated based on new data and approvals. The ComputedRisk is dynamic and decreases over the lifecycle of the ComplianceChecklist, assuming that the approved ComplianceChecklists remain valid in the subspace. As more ComplianceChecklists are approved, the ComputedRisk for new checklists can decrease, facilitating more automated approvals. The ComputedRisk captures the expert knowledge embedded in the approval of previous ComplianceChecklists, making it a valuable metric for risk assessment. The risk score can be scaled to match the customer’s specific risk scoring practices. For example, if a customer scores AI System risk on a scale from 0 to 10, the ComputedRisk can be multiplied by 10.

The RiskMitigationThreshold attribute is a threshold at which the DRCO alerts experts to begin a Risk Mitigation workflow. The Risk Mitigation workflow may include removal from production usage and/or alteration and re-assessment of the underlying AI assets. The RiskAutomationThreshold attribute is a threshold under which DRCO auto-approvals may proceed. The State attribute includes the similar states New, InProgress, Complete, and Approved, as in the AI Use Case Object. The Transcript attribute is a reference to the transcript of the thread spun out from the communication channel 210 for ComplianceChecklist completion.

The ComplianceChecklistDocument Object is an attribute of the ComplianceChecklist Object that defines the metadata of an ComplianceChecklist Document. The ComplianceChecklist Document is an unstructured (text) document, in the primary language of the business, capturing QA pairs as the ComplianceChecklist for the AI governance expert group. The ComplianceChecklistDocument Object includes a template reference attribute and a storage reference attribute. The template reference attribute is a storage reference to the template used for all document instances. The storage reference attribute is a reference to the unstructured storage database where the document is stored.

As shown in FIGS. 2A-2B, and as part of the second workflow 300b, the DRCO agent 202a may refine and enrich the ComplianceChecklist Object, along with its associated attributes, through interactions in the communication channel 210 and interactions with a storage system 280. In the embodiment shown, the DRCO agent 202a creates a sub-thread (i.e., Compliance Checklist Thread) in the communication channel 210 as the discussion platform for the generation and approval of each ComplianceChecklist Object. Upon creating the ComplianceChecklist Object, the DRCO agent 202a may enrich the object from related objects via the app/core 250. The DRCO agent 202a may further enrich the object by identifying and accessing similar ComplianceChecklist Objects from the embedding vector space 270, which stores relevant attributes that may shape the ComplianceChecklist Object. These enrichments may be prompted by the governance team via the communication channel 210, or they may be automatically performed by the DRCO agent 202a. Transcripts of the collaboration between governance teams and the DRCO agent in the sub-thread are appended to the audit trail for each ComplianceChecklist Object.

After creation and enrichment of the ComplianceChecklist Object, the compliance evaluation framework 200a includes a third workflow 300c that includes completing the compiled Compliance Checklist through computing semantic similarity to previous checklists and direct simulation (See FIG. 3). The workflow 300c may overlap with the workflow 300b in that they both further define the ComplianceChecklist Object. But the workflow 300c is focused more on the actual completion and evaluation of the AI asset against the checklist. This may include (1) synthesizing an anonymized evaluation data set from training data (data lineage metadata is used for discovery) and (2) testing the AI asset and record results in the Compliance Checklist. The third workflow 300c may include computing the various checklist risk values and evaluating those risk against the various risk thresholds. Based on the computed risks, the third workflow 300c completes and approve each required compliance checklists for the AI use case – which may include prompting governance teams for expert approval or even auto-approval by the DRCO agent 202a. Thereafter, the state of the associated AI Use Case Object may be updated as completed. The state of the AI Use Case Object may further be updated as approved when all checklists are approved within certain thresholds – this may also include prompting governance teams for expert approval or even auto-approval by the DRCO agent 202a.

The auto-approval of compliance checklists allow certain low-risk checklists to be approved without direct human intervention. This process is governed by configurable risk thresholds and overseen by designated experts to ensure appropriate oversight. In an embodiment, the RiskAutomationThreshold of the ComplianceChecklist Object must be set, defining the maximum acceptable risk score for auto-approval. Auto approval is triggered when the ComputedRisk of a ComplianceChecklist falls below the RiskAutomationThreshold. The designated experts are alerted to the automated approval. After approval, the ComplianceChecklist Object is moved to the “Approved” state.

Similarly, the auto approval of AI Use Case allow approval of certain AI use cases without direct human intervention. This process is also governed by configurable risk thresholds and overseen by designated experts to ensure appropriate oversight. In an embodiment, the RiskAutomationThreshold of the AI Use Case Object must be set, defining the maximum acceptable risk score for auto-approval. Auto approval is triggered when the overall risk score of the AI Use Case is below the configured RiskAutomationThreshold and when all ComplianceChecklists listed in the Required ComplianceChecklists Specification for the AI Use Case have been approved (either manually or automatically). The designated experts are alerted to the automated approval. After approval, the AI Use Case Object is moved to the “Approved” state.

Referring to the workflows 300b and 300c collectively, the completion of the ComplianceChecklists generally involves checklist creation and assignment, collaboration and evidence gathering, checklist completion, and approval and audit trail. An example end-to-end process is explained below.

During checklist creation, for each AI Use Case, relevant ComplianceChecklists are either automatically generated by the DRCO agent 202a (e.g., summarizing the organization’s AI governance policy) or selected from standard templates. Each ComplianceChecklist is associated with a specific area of expertise (e.g., ethics, legal, security, data governance) and is attached to the AI Use Case. The DRCO agent 202a spawns a dedicated collaboration channel (e.g., channel 210), or a thread within the channel, for each ComplianceChecklist. Thereafter, the DRCO agent 202a, acting as a digital employee joins the collaboration channel along with the AI Use Case owner, their team, and the designated expert(s) for each checklist. Within each thread, the DRCO leads the team through the checklist questions, prompting for responses and gathering evidence required to demonstrate compliance with the relevant policies and regulations. The process is conversational and interactive, allowing team members to provide input, ask clarifying questions, and upload supporting documentation as needed. The expert overseeing the checklist is available in the channel to provide guidance, answer questions, and ensure the quality and completeness of responses. As the team works through the checklist, the DRCO records answers to each question, compiles evidence, and updates the ComplianceChecklist Object in the system. The DRCO leverages semantic search to suggest similar, previously approved ComplianceChecklists, which can be referenced to improve consistency and efficiency. Once all questions are answered and sufficient evidence is gathered, the ComplianceChecklist is marked as "Complete" in the workflow. After completion, the checklist enters the approval phase, which may be handled automatically (if risk is below the configured threshold) or require expert review. The transcript of the collaboration thread is appended to the audit trail of the ComplianceChecklist, ensuring a complete record of the discussion, decisions, and evidence. All actions, including completion and approval, are logged for transparency and future auditing.

As ComplianceChecklists are completed, the DRCO agent 202a computes risk scores for each checklist and aggregates them to determine the overall risk of the AI Use Case using a configurable RiskFormula. The AI Use Case can only move to the "Complete" state once all required ComplianceChecklists are attached and marked as "Approved" (either through expert review or automated approval if risk is below the set threshold). When all conditions are met—i.e., all required ComplianceChecklists are approved and the overall risk is below the configured threshold—the AI Use Case itself is eligible for approval. This can be performed automatically or by an expert, depending on risk and configuration. The entire process, including checklist completion, risk assessment, and approvals, is logged.

After evaluation of the Compliance Checklists and AI Use Case, the compliance evaluation framework 200a includes a fourth workflow 300d that includes reviewing and reporting compliance to relevant authorities (See FIG. 3). For example, the DRCO agent 202a generates and publishes an AI Compliance Report for the discovered/detected AI asset to enrolled stakeholders (e.g., internal and external to the company). The DRCO agent 202a continuously monitors the risk and compliance status of AI Use Case Objects, alerting experts if any checklist or use case crosses risk thresholds, ensuring timely mitigation and oversight. As part of workflow 300d, the DRCO agent 202a may generate an AIUseCaseComplianceReport Object that defines the metadata of the AI Use Case Compliance Report. The Compliance Report may be automatically generated by the DRCO agent 202a, summarizing the compliance of the AI Use Case and its ComplianceChecklists. The reports are passed to the AI governance team via channel 210 on completion of the AI Use Case.

The DRCO agent 202a defines the AIUseCaseComplianceReport Object by populating various compliance report attributes, which may be fields of the AIUseCaseComplianceReport Object or even objects themselves. These attributes may include AIUseCase, ReportGenerationMetadata, ReportReference, PublicationCoordinates, and PublicationAuditTraisl. The AIUseCase attribute refers to the parent AI Use Case, the ReportGenerationMetadata attribute refers to the metadata required in a Report Generation service, called by the DRCO agent 202a to generate the report. The ReportReference attribute refers to the storage reference into the unstructured storage database in which the document is stored. The PublicationCoordinates attribute is a list of (channel, list of channel recipients) publication coordinates. The PublicationAuditTrail is a record of publication dates, times, and PublicationCoordinates to which the report was sent.

As shown in FIGS. 2A-2B, the storage system 280 includes a vectorized database (e.g., embedding vector space 270). The vector database stores embeddings of ComplianceChecklists. These embeddings are used for semantic search and risk computation. In the present embodiment, the collection of ComplianceChecklists forms a corpus vectorized in the vector database. The corpus is partitioned by AI type, where each AI Type partition of the corpus is cast into a vector space through an embedding in a vector database, for similarity measure and query. As such, the vector database (e.g., embedding vector space 270) is partitioned in three vector spaces, one for each AI Type (predictive, generative, agentic).

By vectorizing ComplianceChecklists as high-dimensional vectors (embeddings), the risk computations and similarity measures are made more efficient for fast retrieval of similar objects and fast computations of risk values. The vector database also enables the DRCO agent 202a to perform semantic similarity searches that go beyond simple keyword matching. The vector database supports automated risk computation by measuring the similarity between new or in-progress ComplianceChecklists and previously approved ones. The DRCO calculates risk scores based on the vector distance (e.g., cosine similarity) between a checklist and its nearest approved counterpart within the same AI Type and ComplianceChecklistType. This approach leverages historical expert decisions to inform risk levels, enabling more accurate and scalable risk forecasting.

As more ComplianceChecklists are approved and added to the vector database, the system’s ability to assess risk and suggest relevant checklists improves. The embeddings capture expert knowledge and organizational best practices, allowing the DRCO agent 202a to refine its recommendations and risk calculations over time. This creates a feedback loop where the quality and reliability of automated processes increase as the corpus grows. By enabling rapid retrieval of similar, previously approved ComplianceChecklists, the vector database reduces the manual effort required from expert teams. Experts can reuse or adapt existing checklists, focus on higher-level tasks, and accelerate the approval process.

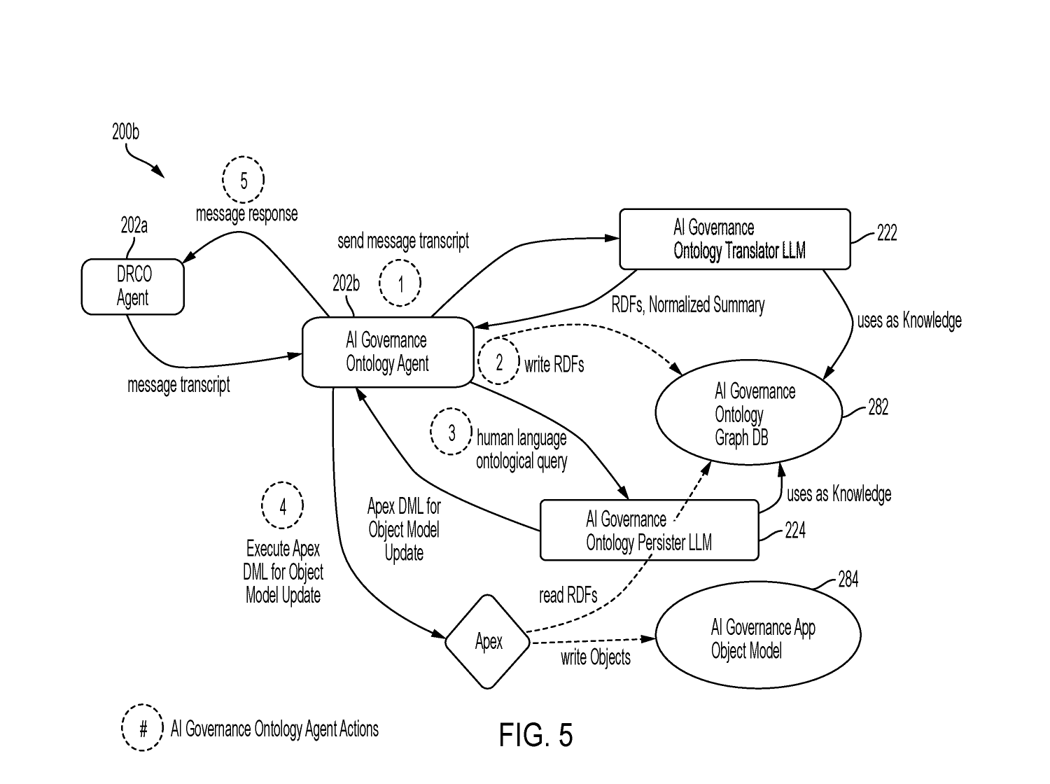

The storage system 280 further includes structured data storage (e.g., data cloud 260 or other storage). The data objects such as AI Use Cases, ComplianceChecklists, and AIUseCaseComplianceReports may be stored in an object database as part of the organization’s object model (e.g., object model 284 in FIG. 5). These objects may be managed using standard database management techniques.

The storage system 280 further includes unstructured data storage (e.g., data cloud 260 or other storage). The ComplianceChecklistDocuments may be stored in a database optimized for unstructured document storage (e.g., data cloud 260 or other storage). Other unstructured documents, such as compliance report text documents may also be stored in the unstructured data storage. The unstructured data storage may support semantic search capabilities through vector/embedding similarity, allowing for efficient retrieval and management of text-based compliance documents.

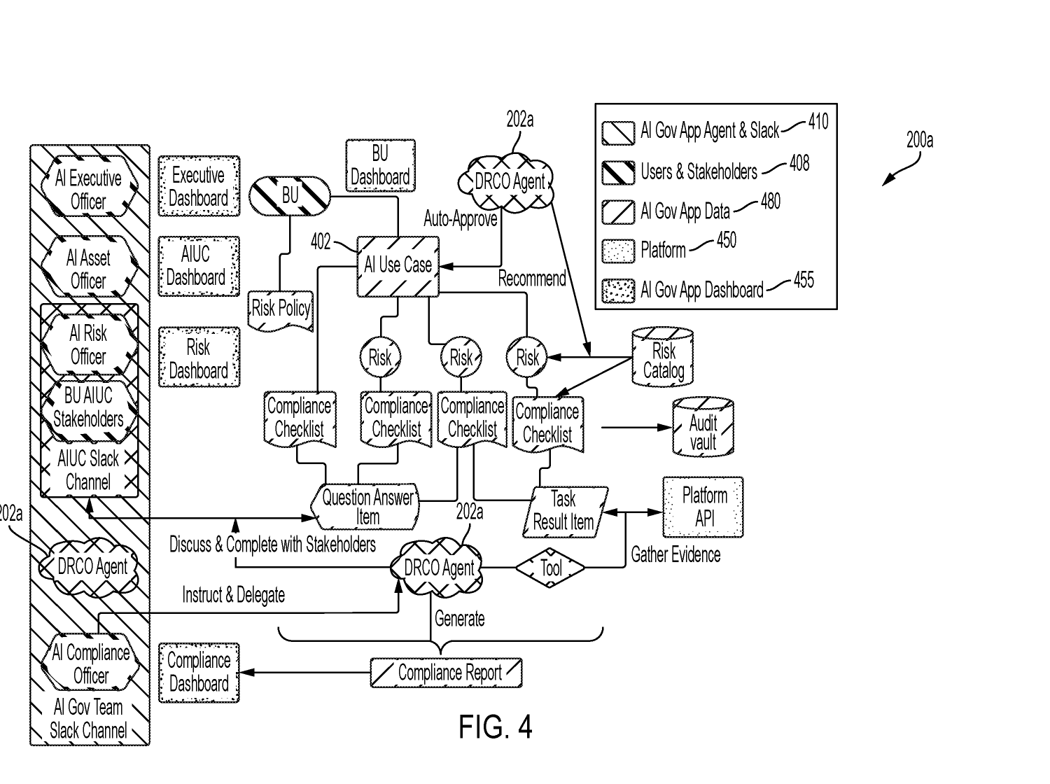

FIG. 4 illustrates an overview of using the compliance evaluation framework 200a in FIG. 3 to assist governance teams in automating AI risk management, according to some embodiments. FIG. 4 illustrates a new AI Use Case 402, which is created by human data entry or by automatic agent discovery described herein. The DRCO agent 202a creates an AI Use Case communication channel for the new AI Use Case 402 (e.g., within an AI Gov Team Slack Channel 410), which allows communication with stakeholders and experts 408. Risks associated with various compliance checklists are calculated and attached to the AI Use Case 402. These may be determined based on direct inputs from stakeholders 408 in combination with searching various AI Gov App Data 480 to determine the risk values of similar AI use cases and their associated compliance checklists. This may be done by performing similarity search to retrieve similar AI use cases and appending their associated risks from risk catalogs (e.g., via platform API 450) to the new AI Use Case 402. The DRCO agent 202a calculates the AI Use Case overall risk through a configured business unit (BU) risk policy formula over the appended risks. The DRCO agent 202a has a configured risk threshold for auto-approval. If the overall risk is less then the risk threshold, the DRCO agent 202a auto-approves the AI Use Case and alerts the stakeholders 408. Various intermediate and final results may be displayed respective dashboards 455 of the AI governance application (e.g., app/core 250).

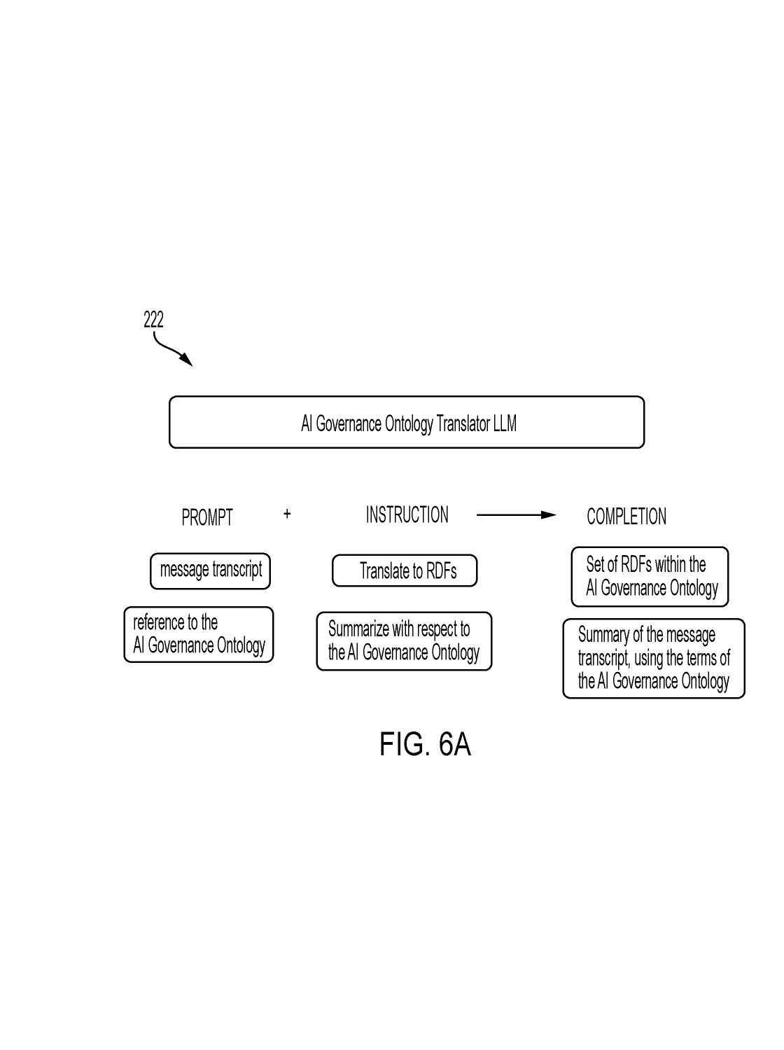

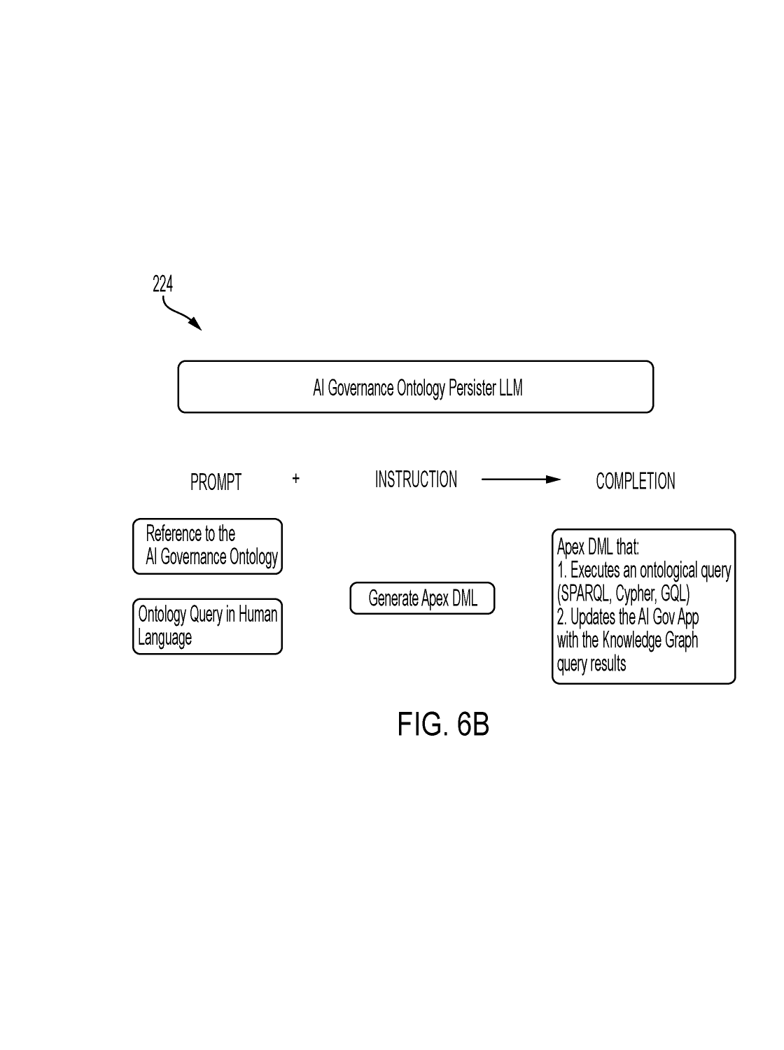

FIG. 5 illustrates the governance ontology framework 200b as part of the AI guardrail framework 200 of FIGS. 2A-2B, according to some embodiments. FIGS. 6A-6B illustrates various components of the governance ontology framework 200b, according to some embodiments. The governance ontology framework 200b is described below with reference to FIGS. 2A-2B, 5, and 6A-6B. The governance ontology framework 200b provides a structured knowledge representation that underpins the operations performed by the DRCO agent 202a in the compliance evaluation framework 200a. The ontology framework 200b enables the DRCO agent 202a to effectively manage and evaluate AI use cases by persisting knowledge updates into the governance knowledge base. These knowledge updates are stored in the storage system 280, in which the DRCO agent 202a uses and retrieves from to perform its tasks.

As shown in FIGS. 2A-2B, the governance ontology framework 200b includes a workflow executed by the AI Governance Ontology (GO) agent 202b and delegated by the DRCO agent 202a. The DRCO agent 202a sends transcripts of the communication channel 210 to the GO agent 202b for processing. The transcripts capture interactions between the DRCO agent 202a and the AI governance team during the execution and validation of AI Use Cases and associated Compliance Checklists. The GO agent 202b translates these transcripts into accurate persisted object models for use in the compliance evaluation framework 200a. Briefly described with respect to FIGS. 2A-2B, the GO agent 202b converts the transcript texts through a translator LLM 222 into a graph data model, such as a resource description framework (RDF) model (e.g., RDF triples). The GO agent 202b updates an AI governance ontology knowledge base graph 282 with the translated RDF model. The GO agent 202b converts the RDF update through a persister LLM 224 into actionable code, such as an object-oriented code like Apex. The generated Apex code is executed to update records stored and used in the storage system 280 (e.g., app/core 250, data cloud 260, and/or embedding vector space 270). Further details of the ontology framework 200b is discussed with respect to FIGS. 5 and 6A-6B.

Referring to FIG. 5, the ontology framework 200b includes an AI governance ontology graph 282, which is at the center of the ontology framework 200b and the knowledge base for AI governance. It extends existing ontologies, such as the "AIRO" ontology (or AI Risk Ontology), to cover requirements from various AI regulations and standards, including the AI Act, ISO/IEC 23894 on AI risk management, and the ISO 31000 series of standards. This comprehensive knowledge base allows the DRCO to align its operations with these regulatory requirements. The ontology graph 282 also defines entities (e.g., AI Use Cases, Compliance Checklists) and their alignment and relationships with the aforementioned international standards. The ontology graph 282 may use RDF triples to represent knowledge in a machine-readable format. The ontology graph is stored in a graph database (e.g., in the storage system 280 or other storage).

A workflow leveraging the ontology graph 282 is described below. After receiving the message transcript from the DRCO agent 202a, the GO agent 202b sends the message transcript to an AI governance ontology translator LLM 222. The translator LLM 222 uses the ontology graph 282 as knowledge to convert the texts of the transcript into RDF triples. These triples represent structured, machine-readable knowledge graph update, encoding entities, relationships, and properties as defined by the ontology. The translator LLM may also summarize the texts of the transcript to output a normalized summary in the terms of the ontology graph 282. Referring to FIG. 6A, the translator LLM is prompted with the message transcript and a reference to the AI governance ontology (i.e., ontology graph 282) as the knowledge base. If the instruction is to translate to RDFs, the result is a set of RDFs within the AI governance ontology (i.e., ontology graph 282). If the instruction is to summarize with respect to the AI governance ontology, the result is a summary of the message transcript, using the terms of the AI governance ontology. The summary may be returned as a message response to the AI governance team in the communication channel 210 via the DRCO agent 202a. The summary may also be used for embedding in vector space for semantic search. In an embodiment, the summary may be converted into RDFs as well. In an embodiment, both instructions of converting to RDFs and summarizing transcript may be automatically triggered.

After receiving translated response from the translator LLM 222, the GO agent 202b writes the translated RDFs into the ontology graph 282 to update the knowledge graph. This update involves adding new entities (e.g., new AI Use Cases), relationships (e.g., which Compliance Checklists are attached to which Use Cases), and properties (e.g., risk levels, domains, localities) to the graph. This update adds a new subgraph (i.e., new or updated RDF triples) into the ontology graph 282.

After updating the ontology graph 282, the GO agent 202b queries an AI governance ontology persister LLM 224 to generate executable code (e.g., Apex code) for object model update. The persister LLM 224 is a specialized LLM that acts as a bridge between the RDF knowledge graph and the object models running in the framework 200a (e.g., on app/core 250). The persister LLM 224 translates ontological queries and subgraph updates into executable database operations (Apex code), ensuring that the AI governance application object model 284 is synchronized with the latest state of the ontology-based knowledge graph 282. Referring to FIG. 6B, the persister LLM 224 is prompted with a an ontological query and a reference to the updated AI governance ontology (i.e., ontology graph 282). The persister LLM 224 is instructed to generate object oriented executable code (e.g., Apex data manipulation language (DML) statements). For example, the instruction may be “"Give me the subgraph that has not yet been persisted to the AI Governance App object model." The executable code may be in the form of an ontological query language appropriate for graph database implementation (e.g., SPARQL, Cypher, GQL). These Apex DML statements when executed persist the knowledge subgraph data into objects (such as AI Use Case Object, Compliance Checklist Object, etc.). The knowledge graph query result set includes the necessary metadata to ensure proper integration and mapping to the AI Governance Application’s object model 284. The integration of the governance knowledge subgraph into the AI governance application object model 284 includes automatic mapping of ontology entities to application objects, such that updates to the ontology knowledge graph are reflected in real time within the operational data structures of the AI governance application.

After generating the graph query language (e.g., Apex DML), the GO agent 202b executes the code to persist the query results into the AI Governance Application’s object model 284. When executed, the query reads the associated RDFs from the ontology graph 282 to write objects into the AI Governance Application’s object model 284. AI Governance Application’s object model 284 is a structured data schema designed to represent, manage, and persist all relevant entities, relationships, and metadata required for comprehensive AI governance, risk management, and compliance (GRC) within the organization’s governance cloud. The data schema defines the various objects herein defined (e.g., AI Use Case Object, ComplianceChecklist Object, etc.). The GO agent 202b thereby is operable to generate and persist compliance-related metadata, including AI Use Case attributes, ComplianceChecklist associations, and risk assessments, as ontological entities and properties, thereby enabling semantic search and automated reasoning over compliance records.

After persisting the updated knowledge subgraph into the object model, the GO agent 202b updates the work it has executed in a message response. The message response may be sent to the communication channel 210 by the DRCO agent 202a.

### Computer and Network Environment

FIG. 7A is a simplified diagram illustrating a computing device implementing the AI guardrail framework 200 described in FIGS. 2-6, according to one embodiment described herein. As shown in FIG. 7A, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

In another embodiment, processor 710 may comprise multiple microprocessors and/or memory 720 may comprise multiple registers and/or other memory elements such that processor 710 and/or memory 720 may be arranged in the form of a hardware-based neural network, as further described in FIG. 7B.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for AI guardrail module 730 that may be used to implement and/or emulate the systems and models, and/or to implement any of the methods described further herein. AI guardrail module 730 may receive input 740 such as an input training data (e.g., AI asset metadata, ontology knowledge base, object model framework, AI governance team input) via the data interface 715 and generate an output 750 which may be an AI use case transcript, a compliance report, an updated knowledge graph, etc.

The data interface 715 may comprise a communication interface, a user interface (such as a voice input interface, a graphical user interface, and/or the like). For example, the computing device 700 may receive the input 740 (such as a training dataset comprising AI asset metadata, ontology knowledge base, object model framework) from a networked database via a communication interface. Or the computing device 700 may receive the input 740, such as AI governance team input, from a user via the user interface.

In some embodiments, the AI guardrail module 730 is configured to assist AI governance teams to assess AI asset compliance in an automated AI governance workflow. This includes the autonomous discovery of AI assets, autonomous evaluation of AI asset compliance, and autonomous updates to the AI governance knowledge base based on the autonomous evaluation. The AI guardrail module 730 may further include use case compliance submodule 731 (e.g., the DRCO agent 202a executing within the compliance evaluation module 200a in FIGS. 2A-2B). The submodule 731 may be configured to perform the autonomous discovery of AI assets and the autonomous evaluation of AI asset compliance. The AI guardrail module 730 may further include ontology update submodule 732 (e.g., the GO agent 202b executing within the governance ontology framework 200b in FIGS. 2A-2B). The submodule 732 may be configured to perform the autonomous updates to the AI governance knowledge base and mapped object models.

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 7B is a simplified diagram illustrating the neural network structure implementing the AI guardrail module 730 described in FIG. 7A, according to some embodiments. In some embodiments, the AI guardrail module 730 and/or one or more of its submodules 731-732 may be implemented at least partially via an artificial neural network structure shown in FIG. 7B. The neural network comprises a computing system that is built on a collection of connected units or nodes, referred to as neurons (e.g., 744, 745, 746). Neurons are often connected by edges, and an adjustable weight (e.g., 751, 752) is often associated with the edge. The neurons are often aggregated into layers such that different layers may perform different transformations on the respective input and output transformed input data onto the next layer.

For example, the neural network architecture may comprise an input layer 741, one or more hidden layers 742 and an output layer 743. Each layer may comprise a plurality of neurons, and neurons between layers are interconnected according to a specific topology of the neural network topology. The input layer 741 receives the input data (e.g., 740 in FIG. 7A), such as AI asset metadata, ontology knowledge base, object model framework, etc. The number of nodes (neurons) in the input layer 741 may be determined by the dimensionality of the input data (e.g., the length of a vector of the AI asset metadata etc.). Each node in the input layer represents a feature or attribute of the input.

The hidden layers 742 are intermediate layers between the input and output layers of a neural network. It is noted that two hidden layers 742 are shown in FIG. 7B for illustrative purpose only, and any number of hidden layers may be utilized in a neural network structure. Hidden layers 742 may extract and transform the input data through a series of weighted computations and activation functions.

For example, as discussed in FIG. 7A, the AI guardrail module 730 receives an input 740 of AI asset data and transforms the input into an output 750 of a compliance report. To perform the transformation, each neuron receives input signals, performs a weighted sum of the inputs according to weights assigned to each connection (e.g., 751, 752), and then applies an activation function (e.g., 761, 762, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 741 is transformed into rather different values indicative data characteristics corresponding to a task that the neural network structure has been designed to perform.

The output layer 743 is the final layer of the neural network structure. It produces the network's output or prediction based on the computations performed in the preceding layers (e.g., 741, 742). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI guardrail module 730 and/or one or more of its submodules 731-732 may comprise the transformative neural network structure of layers of neurons, and weights and activation functions describing the non-linear transformation at each neuron. Such a neural network structure is often implemented on one or more hardware processors 710, such as a graphics processing unit (GPU). An example neural network may be a recurrent neural network, a convolutional neural network, and/or the like.

In one embodiment, the AI guardrail module 730 and its submodules 731-732 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 120) may receive a natural language input (such as a question) and generate a natural language output (such as an answer to the question).

In one embodiment, the AI guardrail module 730 and its submodules 731-732 may be implemented by hardware, software and/or a combination thereof. For example, the AI guardrail module 730 and its submodules 731-732 may comprise a specific neural network structure implemented and run on various hardware platforms 760, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 760 used to implement the neural network structure is specifically configured based on factors such as the complexity of the neural network, the scale of the tasks (e.g., training time, input data scale, size of training dataset, etc.), and the desired performance.

For example, to deploy the AI guardrail module 730 and its submodules 731-732 and/or any other neural network models, such as those within the submodules 731-732 (e.g., translator LLM 222 and persister LLM 224) onto hardware platform 760, the neural network based modules 730 and its submodules 731-732 may be optimized for deployment by converting it to a suitable format, such as ONNX or TensorRT, to improve performance and compatibility. Next, depending on the size and workload requirements for modules 730 and its submodules 731-732, hardware types may be chosen for deployment, e.g., processing capacity, GPU memory size, and/or the like. Frameworks and drivers for the chosen hardware 760 frameworks and drivers may thus be installed, such as PyTorch, TensorFlow, or CUDA, to support the hardware platform 760. Then, weights and parameters of the AI guardrail module 730 and its submodules 731-732 may be loaded to the hardware 760. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI guardrail module 730 and its submodules 731-732 may be deployed as a service, then they may be integrated with an API endpoint, using tools like Flask, FastAPI, or a cloud platform serverless services, and is accessible by a remote user via a network.

In another embodiment, some or all of layers 741, 742, 743 and/or neurons 742, 745, 746, and operations there between such as activations 761, 762, and/or the like, of the AI guardrail module 730 and its submodules 731-732 may be realized via one or more ASICs. For example, each neuron 742, 745 and 746 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI guardrail module 730 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI guardrail module 730 and one or more of its submodules 731-732 may be trained by iteratively updating the underlying parameters (e.g., weights 751, 752, etc., bias parameters and/or coefficients in the activation functions 761, 762 associated with neurons) of the neural network based on a loss. For example, during forward propagation, the training data such as input data 740 is fed into the neural network. The data flows through the network's layers 741, 742, with each layer performing computations based on its weights, biases, and activation functions until the output layer 743 produces the network's output 750. In some embodiments, output layer 743 produces an intermediate output on which the network’s output 750 is based.

The output generated by the output layer 743 is compared to the expected output (e.g., a “ground-truth” such as the corresponding summary of an input training document) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 743 to the input layer 741 of the neural network. These gradients quantify the sensitivity of the network's output to changes in the parameters. The chain rule of calculus is applied to efficiently calculate these gradients by propagating the gradients backward from the output layer 743 to the input layer 741.

In one embodiment, the neural network based AI guardrail module 730 and one or more of its submodules 731-732 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning – in other words, backward propagation and forward propagation may occur for both “training” and “inference” stages of the neural network mode.

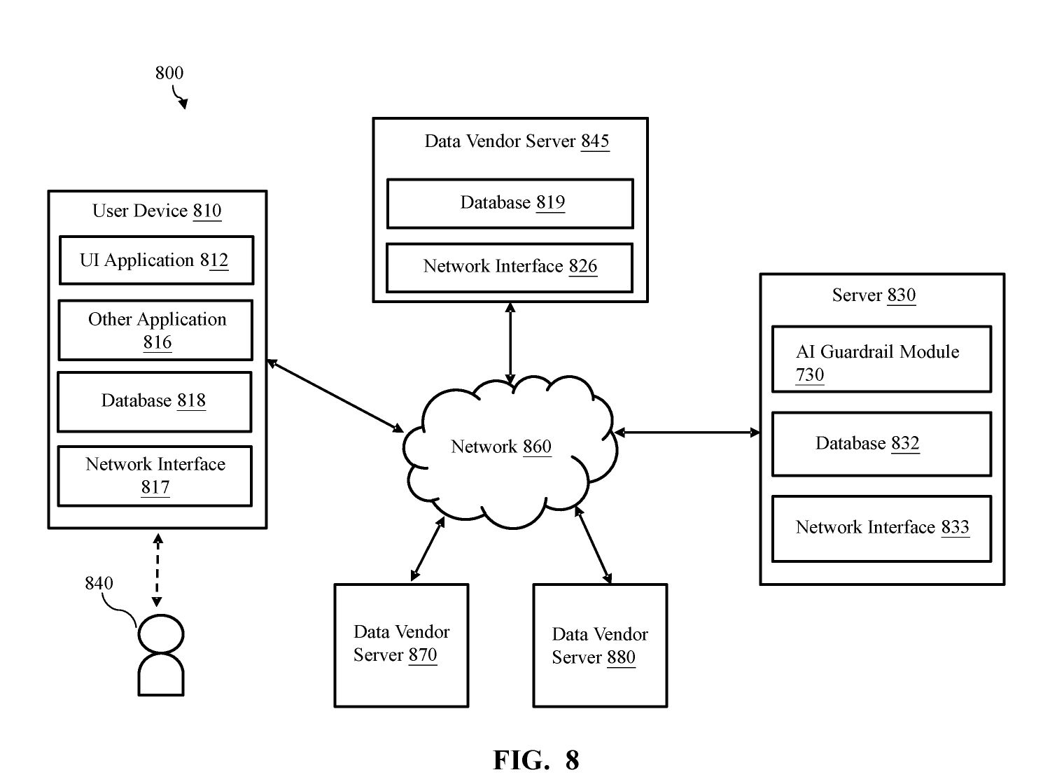

In some embodiments, AI guardrail module 730 and its submodules 731-732 may be housed at a centralized server (e.g., computing device 700) or one or more distributed servers. For example, one or more of AI guardrail module 730 and its submodules 731-732 may be housed at external server(s). The different modules may be communicatively coupled by building one or more connections through application programming interfaces (APIs) for each respective module. Additional network environment for the distributed servers hosting different modules and/or submodules may be discussed in FIG. 8.

During a backward pass, parameters of the neural network are updated backwardly from the last layer to the input layer (backpropagating) based on the computed negative gradient using an optimization algorithm to minimize the loss. The backpropagation from the last layer 743 to the input layer 741 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as predicting risk values of new AI use cases (e.g., based on risk values of similar AI use cases in the input knowledge base).

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in enterprise and regulated environments by providing structured oversight and automated compliance in evaluating AI asset compliance. For example, the ontology update module 732 improves the knowledge base of the AI guardrail module 730, such as by translating and persisting transcripts into updated subgraphs, which the use case compliance module 731 uses for running object models.

FIG. 8 is a simplified block diagram of a networked system 800 suitable for implementing the AI guardrail framework 200 described in FIGS. 2-6 and other embodiments described herein. In one embodiment, system 800 includes the user device 810 which may be operated by user 840, data vendor servers 845, 870 and 880, server 830, and other forms of devices, servers, and/or software components that operate to perform various methodologies in accordance with the described embodiments. Exemplary devices and servers may include device, stand-alone, and enterprise-class servers which may be similar to the computing device 700 described in FIG. 7A, operating an OS such as a MICROSOFT® OS, a UNIX® OS, a LINUX® OS, or other suitable device and/or server-based OS. It can be appreciated that the devices and/or servers illustrated in FIG. 8 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 810, data vendor servers 845, 870 and 880, and the server 830 may communicate with each other over a network 860. User device 810 may be utilized by a user 840 (e.g., a driver, a system admin, etc.) to access the various features available for user device 810, which may include processes and/or applications associated with the server 830 to receive an output data anomaly report.

User device 810, data vendor server 845, and the server 830 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 800, and/or accessible over network 860.

User device 810 may be implemented as a communication device that may utilize appropriate hardware and software configured for wired and/or wireless communication with data vendor server 845 and/or the server 830. For example, in one embodiment, user device 810 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 810 of FIG. 8 contains a user interface (UI) application 812, and/or other applications 816, which may correspond to executable processes, procedures, and/or applications with associated hardware. For example, the user device 810 may receive a message indicating an AI Use Case risk value from the server 830 and display the message via the UI application 812. In other embodiments, user device 810 may include additional or different modules having specialized hardware and/or software as required.

In one embodiment, UI application 812 may communicatively and interactively generate a UI for an AI agent implemented through the AI guardrail module 730 (e.g., an LLM agent) at server 830. In at least one embodiment, a user operating user device 810 may enter a user utterance, e.g., via text or audio input, such as a question, uploading a document, and/or the like via the UI application 812. Such user utterance may be sent to server 830, at which AI guardrail module 730 may generate a response via various processes described herein. The AI guardrail module 730 may thus cause a display of an AI compliance report at UI application 812 (e.g., via a communication channel) and interactively update the display in real time with the user query.

In various embodiments, user device 810 includes other applications 816 as may be desired in particular embodiments to provide features to user device 810. For example, other applications 816 may include security applications for implementing client-side security features, programmatic client applications for interfacing with appropriate application programming interfaces (APIs) over network 860, or other types of applications. Other applications 816 may also include communication applications, such as email, texting, voice, social networking, and IM applications that allow a user to send and receive emails, calls, texts, and other notifications through network 860. For example, the other application 816 may be an email or instant messaging application that receives a prediction result message from the server 830. Other applications 816 may include device interfaces and other display modules that may receive input and/or output information. For example, other applications 816 may contain software programs for asset management, executable by a processor, including a graphical user interface (GUI) configured to provide an interface to the user 840 to view various metrics evaluating the AI use case.

User device 810 may further include database 818 stored in a transitory and/or non-transitory memory of user device 810, which may store various applications and data and be utilized during execution of various modules of user device 810. Database 818 may store user profile relating to the user 840, predictions previously viewed or saved by the user 840, historical data received from the server 830, and/or the like. In some embodiments, database 818 may be local to user device 810. However, in other embodiments, database 818 may be external to user device 810 and accessible by user device 810, including cloud storage systems and/or databases that are accessible over network 860.

User device 810 includes at least one network interface component 817 adapted to communicate with data vendor server 845 and/or the server 830. In various embodiments, network interface component 817 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 845 may correspond to a server that hosts database 819 to provide training datasets including AI governance ontology knowledge base 282 to the server 830. The database 819 may be implemented by one or more relational database, distributed databases, cloud databases, and/or the like.

The data vendor server 845 includes at least one network interface component 826 adapted to communicate with user device 810 and/or the server 830. In various embodiments, network interface component 826 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 845 may send asset information from the database 819, via the network interface 826, to the server 830.

The server 830 may be housed with the AI guardrail module 730 and its submodules described in FIG. 7A. In some implementations, AI guardrail module 730 may receive data from database 819 at the data vendor server 845 via the network 860 to generate compliance reports. The generated reports may also be sent to the user device 810 for review by the user 840 via the network 860.

In one embodiment, an AI agent implementing the AI guardrail module 730 and its submodules described in FIG. 7A may be built based on an LLM as described in FIG. 7B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the AI guardrail module 730 and its submodules described in FIG. 7A may be implemented as a cloud-based AI agent which may be accessed by user device 810 via a chatbot application, a web application, customer support or SaaS applications. In another implementation, a client-side AI agent component may be delivered from the server 830 to user device 810 for local installation such that the client-side AI agent may be installed and runs directly on the user’s device. Such local AI agent on the user device 810 may be available offline to adapt to privacy-sensitive applications. In another implementation, the AI agent implementing the AI guardrail module 730 and its submodules described in FIG. 7A may adopt a hybrid cloud and client-based structure to balance computing speed, cost and privacy. For example, a local AI agent may handle basic AI queries locally, but complex queries may be sent to server 830 to process.

The database 832 may be stored in a transitory and/or non-transitory memory of the server 830. In one implementation, the database 832 may store data obtained from the data vendor server 845. In one implementation, the database 832 may store parameters of the AI guardrail module 730. In one implementation, the database 832 may store previously generated AI Use Case objects, and the corresponding input feature vectors.

In some embodiments, database 832 may be local to the server 830. However, in other embodiments, database 832 may be external to the server 830 and accessible by the server 830, including cloud storage systems and/or databases that are accessible over network 860.

The server 830 includes at least one network interface component 833 adapted to communicate with user device 810 and/or data vendor servers 845, 870 or 880 over network 860. In various embodiments, network interface component 833 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 860 may be implemented as a single network or a combination of multiple networks. For example, in various embodiments, network 860 may include the Internet or one or more intranets, landline networks, wireless networks, and/or other appropriate types of networks. Thus, network 860 may correspond to small scale communication networks, such as a private or local area network, or a larger scale network, such as a wide area network or the Internet, accessible by the various components of system 800.

### Example Work Flows

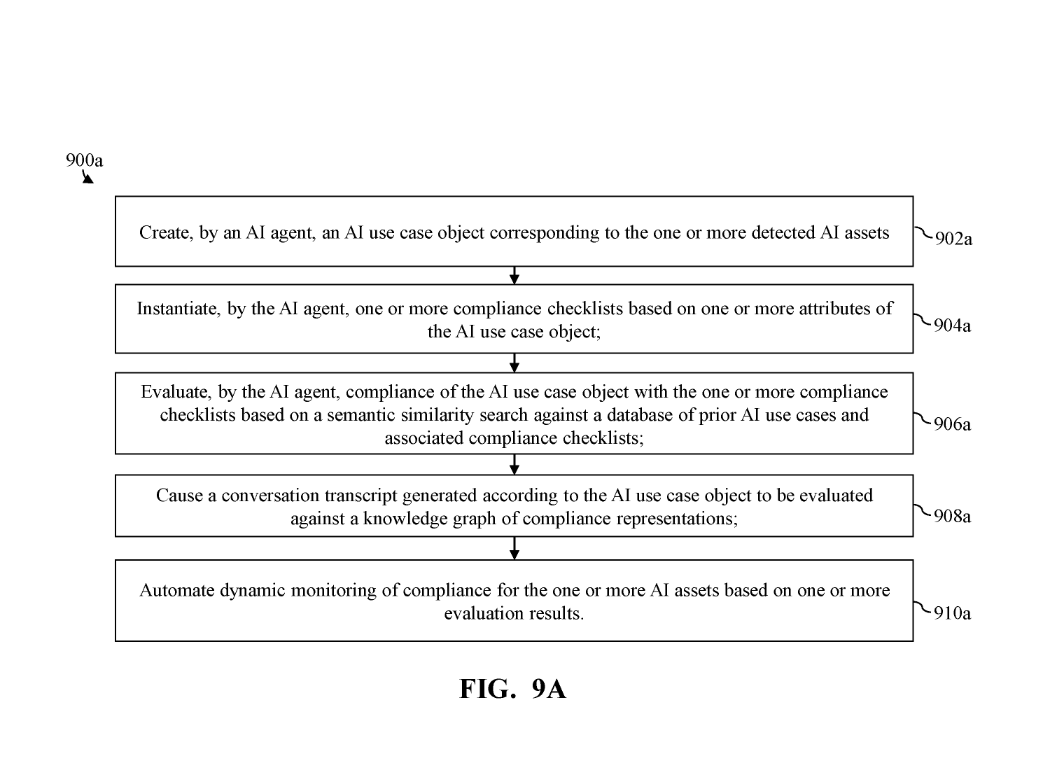

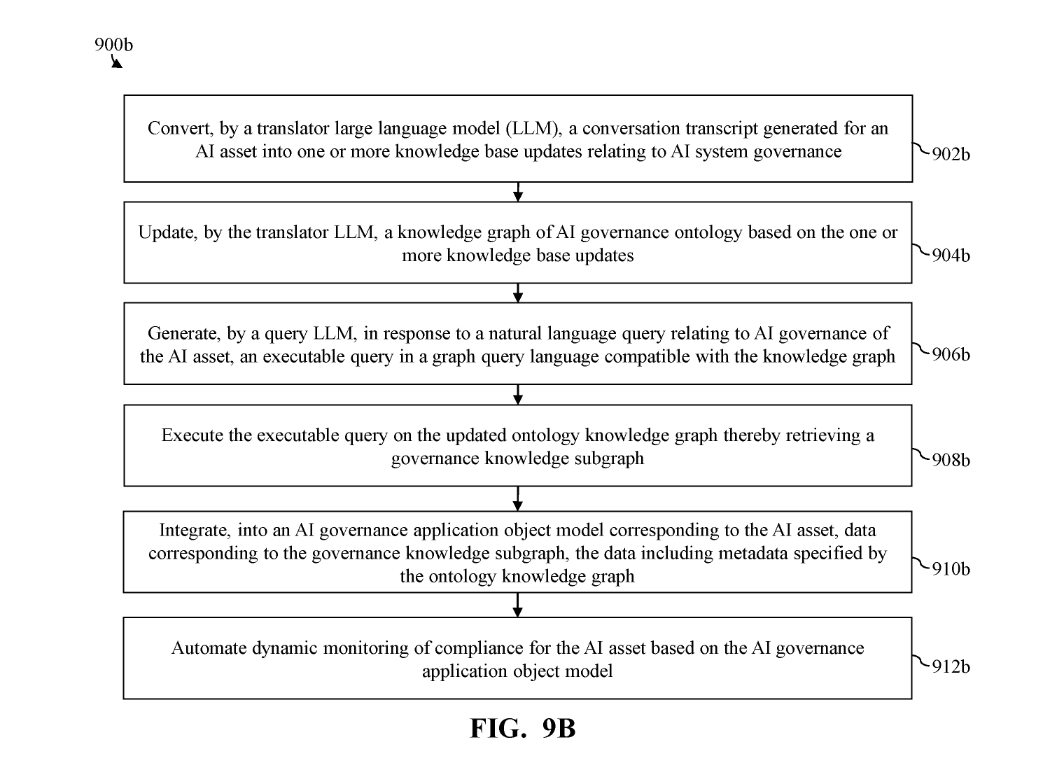

FIG. 9A is an example logic flow diagram illustrating a method 900a of automating artificial intelligence (AI) risk management and compliance verification based on the framework shown in FIGS. 2-6, according to some embodiments described herein. One or more of the processes of method 900a may be implemented, at least in part, in the form of executable code stored on non-transitory, tangible, machine-readable media that when run by one or more processors may cause the one or more processors to perform one or more of the processes. In some embodiments, method 900a corresponds to the operation of the AI guardrail module 730 (e.g., FIGS. 7A and 8), and specifically to the use case compliance module 731 that performs autonomous discovery of AI assets to generate AI use case objects, as well as autonomous evaluation of AI use case asset compliance, leveraging object models mapped from a knowledge base, which the ontology update module 732 continuously and automatically updates based on generated transcripts from the use case compliance module 731.

In some embodiments, method 900a is performed by a system such as computing device 700, user device 810, server 830, or another device or combination of devices. Inputs (e.g., message transcripts) may be received via a data interface such as data interface 715, network interface 817, network interface 833, or via a data interface that is integrated with a device. For example, UI Application 812 may receive user inputs via a text input interface (e.g., keyboard), audio input (e.g., microphone), video interface (e.g., camera), or other interface for receiving user inputs (e.g., a mouse or touch display).

As illustrated, the method 900a includes a number of enumerated steps, but aspects of the method 900a may include additional steps before, after, and in between the enumerated steps. In some aspects, one or more of the enumerated steps may be omitted or performed in a different order.

At step 902a, the method creates, by an AI agent (e.g., DRCO agent 202a), an AI use case object (e.g., AI Use Case 402) corresponding to the one or more detected AI assets. The step 902a may include automatically detecting unapproved AI assets within a target AI system, and creating the AI use case object for the detected unapproved AI assets.

At step 904a, the method instantiates, by the AI agent, one or more compliance checklists based on one or more attributes of the AI use case object. The compliance checklists may be formed as one or more ComplianceChecklist Objects, which are attached to the associated AI Use Case Object. Attributes of the AI Use Case Object and ComplianceChecklist Objects may be enriched through user input (e.g., via channel 210) and through analyzing risk values of existing similar AI Use Case Objects (e.g., via storage system 280). For example, at step 906a, the method evaluates, by the AI agent, compliance of the AI use case object with the one or more compliance checklists based on a semantic similarity search against a database of prior AI use cases and associated compliance checklists (e.g., data cloud 260, knowledge base 282, embedding vector space 270, etc.).

At step 908a, the method causes a conversation transcript generated according to the AI use case object to be evaluated against a knowledge graph of compliance representations (e.g., knowledge base 282). This evaluation may be performed by the GO agent 202b as part of the governance ontology framework 200b described herein.

At step 910a, the method automates dynamic monitoring of compliance for the one or more AI assets based on one or more evaluation results (e.g., through auto-approval of compliance checklists and use cases, automatic detection of AI assets for instantiating new AI use cases, automatic updates to risk scores based on changes and updates to existing AI use cases, etc.). The step 910a may include continuous evaluation of compliance status and risk using AI-driven classification, similarity analysis, and expert input. For example, the DRCO agent 202a monitors risk thresholds in real time, triggering alerts and mitigation workflows as needed. All compliance activities, evidence, and communications are logged for auditability (e.g., via message transcript) for further updates and training to the underlying governance knowledge base.

FIG. 9B is an example logic flow diagram illustrating a method 900b of automating artificial intelligence (AI) risk management based on the framework shown in FIGS. 2-6, according to some embodiments described herein. One or more of the processes of method 900b may be implemented, at least in part, in the form of executable code stored on non-transitory, tangible, machine-readable media that when run by one or more processors may cause the one or more processors to perform one or more of the processes. In some embodiments, method 900b corresponds to the operation of the AI guardrail module 730 (e.g., FIGS. 7A and 8), and specifically to the ontology update module 732 that performs autonomous updates to the AI governance knowledge base and mapped object models, which the compliance module 731 uses to execute compliance tasks.

In some embodiments, method 900b is performed by a system such as computing device 700, user device 810, server 830, or another device or combination of devices. Inputs (e.g., message transcripts) may be received via a data interface such as data interface 715, network interface 817, network interface 833, or via a data interface that is integrated with a device. For example, UI Application 812 may receive user inputs via a text input interface (e.g., keyboard), audio input (e.g., microphone), video interface (e.g., camera), or other interface for receiving user inputs (e.g., a mouse or touch display).

As illustrated, the method 900b includes a number of enumerated steps, but aspects of the method 900b may include additional steps before, after, and in between the enumerated steps. In some aspects, one or more of the enumerated steps may be omitted or performed in a different order.

At step 902b, the method converts, by a translator large language model (LLM) (e.g., translator LLM 222), a conversation transcript generated for an AI asset (e.g., AI Use Case 402) into one or more knowledge base updates relating to AI system governance. For example, the one or more knowledge base updates may be a graph data model having a set of RDF triples. The translator LLM may also generate a normalized summary of the transcript.

At step 904b, the method updates, by the translator LLM, a knowledge graph of AI governance ontology (e.g., knowledge base 282) based on the one or more knowledge base updates. For example, the set of RDF triples is written into the knowledge base 282 as a subgraph.

At step 906b, the method generates, by a query LLM (e.g., persister LLM 224), in response to a natural language query relating to AI governance of the AI asset (e.g., an ontological query in human language), an executable query (e.g., Apex code) in a graph query language compatible with the knowledge graph.

At step 908b, the method executes the executable query on the updated ontology knowledge graph thereby retrieving a governance knowledge subgraph. The execution includes reading from the knowledge base 282 the knowledge subgraph and mapping them into corresponding objects.

At step 910b, the method integrates into an AI governance application object model corresponding to the AI asset (e.g., AI governance application object model 284), data corresponding to the governance knowledge subgraph, the data including metadata specified by the ontology knowledge graph. The data may be integrated by writing the mapped data objects into the object model 284. The data objects may be AI Use Case Objects, ComplianceChecklist Objects, etc. The metadata may include various attributes of the mapped data objects.

At step 912b, the method automate dynamic monitoring of compliance for the AI asset based on the updated AI governance application object model (e.g., object model 284), which includes the new mapped data objects written therein. Working with the compliance evaluation framework 200a, the automatic dynamic monitoring may include automatically instantiating an AI Use Case Object within the object model by extracting and mapping relevant object attributes—including AI type, business purpose, region, vertical, team, and associated compliance requirements—from the updated ontology knowledge graph 282. The automatic monitoring further includes evaluating the instantiated AI Use Case Object by programmatically attaching and completing one or more ComplianceChecklist Objects, each linked to corresponding ComplianceChecklistDocument instances. The evaluation includes automated risk computation using a configurable RiskFormula that aggregates expert-assigned and computed risk scores derived from ontological similarity measures and historical approvals, thereby enabling real-time compliance status determination and triggering of risk mitigation or approval workflows as specified by the AI governance policy.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of automating artificial intelligence (AI) risk management, the method comprising:
converting, by a translator large language model (LLM), a conversation transcript generated for an AI asset into one or more knowledge base updates relating to AI system governance;
updating, by the translator LLM, a knowledge graph of AI governance ontology based on the one or more knowledge base updates;
generating, by a query LLM, in response to a natural language query relating to AI governance of the AI asset, an executable query in a graph query language compatible with the knowledge graph;
executing the executable query on the updated ontology knowledge graph thereby retrieving a governance knowledge subgraph;
integrating, into an AI governance application object model corresponding to the AI asset, data corresponding to the governance knowledge subgraph, the data including metadata specified by the ontology knowledge graph;
automating dynamic monitoring of compliance for the AI asset based on the AI governance application object model; and
blocking data traffic from one of the one or more AI assets in response to identifying one or more compliance violation of the one AI asset from the dynamic monitoring.

2. The method of claim 1, wherein the AI governance ontology is an extension of a standardized AI risk ontology, and the knowledge graph includes Resource Description Framework (RDF) triples structured according to the AI governance ontology.

3. The method of claim 1, wherein the data corresponding to the governance knowledge subgraph includes a first data object and a second data object attached to the first data object.

4. The method of claim 1, wherein the converting of the conversation transcript includes:
receiving, by a first AI agent, the conversation transcript;
prompting, by the first AI agent , the translator LLM with the conversation transcript and a reference to the knowledge graph of AI governance ontology; and
receiving, by the first AI agent from the translator LLM, a translated set of the conversation transcript as a graph data model corresponding to the one or more knowledge base updates.

5. The method of claim 4, wherein the updating of the knowledge graph includes integrating the graph data model into the knowledge graph.

6. The method of claim 1, wherein the generating of the executable query includes:
prompting, by a first AI agent, the query LLM with the natural language query and a reference to the knowledge graph of AI governance ontology; and
receiving, by the first AI agent from the query LLM, the executable query as object oriented executable code for updating the AI governance application object model.

7. The method of claim 6, wherein the integration of the governance knowledge subgraph into the AI governance application object model includes executing the executable code for automatic mapping of ontology entities to application objects, such that updates to the ontology knowledge graph are reflected in real time within operational data structures of the AI governance application object model.

8. The method of claim 1, wherein the automatic dynamic monitoring of compliance for the AI asset includes an automatic instantiating and evaluating of an AI Use Case Object within the AI governance application object model by mapping relevant object attributes from the updated ontology knowledge graph to the AI Use Case Object.

9. A system for automating artificial intelligence (AI) risk management, the system comprising:
a memory that stores one or more neural network models and a plurality of processor-executable instructions;
a communication interface that receives a conversation transcript generated for an AI asset; and
one or more hardware processors that read and execute the plurality of processor-executable instructions from the memory, wherein the plurality of processor-executable instructions are configurable to cause the system to perform operations comprising:
converting, by a translator large language model (LLM), the conversation transcript generated for the AI asset into one or more knowledge base updates relating to AI system governance;
updating, by the translator LLM, a knowledge graph of AI governance ontology based on the one or more knowledge base updates;
generating, by a query LLM, in response to a natural language query relating to AI governance of the AI asset, an executable query in a graph query language compatible with the knowledge graph;
executing the executable query on the updated ontology knowledge graph thereby retrieving a governance knowledge subgraph;
integrating, into an AI governance application object model corresponding to the AI asset, data corresponding to the governance knowledge subgraph, the data including metadata specified by the ontology knowledge graph; and
automating dynamic monitoring of compliance for the AI asset based on the AI governance application object model.

10. The system of claim 9, wherein the AI governance ontology is an extension of a standardized AI risk ontology, and the knowledge graph includes Resource Description Framework (RDF) triples structured according to the AI governance ontology.

11. The system of claim 9, wherein the data corresponding to the governance knowledge subgraph includes a first data object and a second data object attached to the first data object.

12. The system of claim 9, wherein the converting of the conversation transcript includes:
receiving, by a first AI agent, the conversation transcript;
prompting, by the first AI agent, the translator LLM with the conversation transcript and a reference to the knowledge graph of AI governance ontology; and
receiving, by the first AI agent from the translator LLM, a translated set of the conversation transcript as a graph data model corresponding to the one or more knowledge base updates.

13. The system of claim 9, wherein the generating of the executable query includes:
prompting, by a first AI agent, the query LLM with the natural language query and a reference to the knowledge graph of AI governance ontology; and
receiving, by the first AI agent from the query LLM, the executable query as object oriented executable code for updating the AI governance application object model.

14. The system of claim 13, wherein the integration of the governance knowledge subgraph into the AI governance application object model includes executing the executable code for automatic mapping of ontology entities to application objects, such that updates to the ontology knowledge graph are reflected in real time within operational data structures of the AI governance application object model.

15. The system of claim 9, wherein the automatic dynamic monitoring of compliance for the AI asset includes an automatic instantiating and evaluating of an AI Use Case Object within the AI governance application object model by mapping relevant object attributes from the updated ontology knowledge graph to the AI Use Case Object.

16. A non-transitory machine-readable medium comprising a plurality of instructions, executable by one or more processors, wherein the plurality of instructions are configurable to cause the one or more processors to perform operations comprising:
converting, by a translator large language model (LLM), a conversation transcript generated for an AI asset into one or more knowledge base updates relating to AI system governance;
updating, by the translator LLM, a knowledge graph of AI governance ontology based on the one or more knowledge base updates;
generating, by a query LLM, in response to a natural language query relating to AI governance of the AI asset, an executable query in a graph query language compatible with the knowledge graph;
executing the executable query on the updated ontology knowledge graph thereby retrieving a governance knowledge subgraph;
integrating, into an AI governance application object model corresponding to the AI asset, data corresponding to the governance knowledge subgraph, the data including metadata specified by the ontology knowledge graph; and
automating dynamic monitoring of compliance for the AI asset based on the AI governance application object model.

17. The medium of claim 16, wherein the AI governance ontology is an extension of a standardized AI risk ontology, and the knowledge graph includes Resource Description Framework (RDF) triples structured according to the AI governance ontology.

18. The medium of claim 16, wherein the data corresponding to the governance knowledge subgraph includes a first data object and a second data object attached to the first data object.

19. The medium of claim 16, wherein the integration of the governance knowledge subgraph into the AI governance application object model includes automatic mapping of ontology entities to application objects, such that updates to the ontology knowledge graph are reflected in real time within operational data structures of the AI governance application object model.

20. The medium of claim 16, wherein the automatic dynamic monitoring of compliance for the AI asset includes an automatic instantiating and evaluating of an AI Use Case Object within the AI governance application object model by mapping relevant object attributes from the updated ontology knowledge graph to the AI Use Case Object.
